(19) United States
(12) Patent Application Publication
(10) Pub. No.: US 2003/0151749 A1
(43) Pub. Date: Aug. 14, 2003

(54) Interferometric optical surface comparison apparatus and method thereof

(75) Inventors: Yeon-Soo Kim, Daejon (KR); Hyun-Sook Kim, Daejon (KR)

Correspondence Address: SCULLY SCOTT MURPHY & PRESSER, PC, 400 GARDEN CITY PLAZA, GARDEN CITY, NY, 11530

(73) Assignee: Agency for Defense Development, Daejon (KR)

(21) Appl. No.: 10/361,212

(22) Filed: Feb. 10, 2003

(30) Foreign Application Priority Data
Feb. 9, 2002 (KR) 07769/2002

(51) Int. Cl. G01B 9/02

(52) U.S. Cl. 356/512

(57) ABSTRACT

A surface comparison apparatus for measuring surface characteristics of a specimen through which visible ray can not be transmitted comprises: a light source generating light having a predetermined wavelength; an optical device changing the light into collimated light; an irradiating unit for irradiating the collimated rays on both surfaces of a specimen which needs to be measured after dividing them into two paths and making the lights, which are reflected on both surfaces, be focused on opposite direction of the incident light after passing through the paths and be interfered with each other; and a display means for displaying the interfered lights which are made by interfering the reflected lights, and thereby, a parallelism or surface characteristics for both surfaces of the specimen can be measured simultaneously through an interference pattern which is obtained by dividing the light into two paths, irradiating the light on both surfaces of the specimen, and reflecting to be interfered with each other, and an interferometer can be constructed and aligned in a simple way.

### BACKGROUND OF THE INVENTION

1. Field of the Invention

The present invention relates to a plane surface measurement apparatus, and particularly, to an optical interferometric surface comparison apparatus for comparing and measuring relative surface characteristics of a thin window type non-transparent plate through which visible light cannot be transmitted.

2. Description of the Background Art

A thin plate type infrared window such as a Germanium window, which is used in a FLIR (forward looking infrared) equipment mounted on the top or nose or bottom of a helicopter or UAV (unmanned aerial vehicle), or an Infrared filter plate, which has, a function of selecting the special wavelength in equipment for measuring the modulation transfer function (MTF) of an infrared optical system, etc., is installed in the optical path through which the infrared rays are transmitted. Therefore, surface characteristics, that is, non-parallelism and surface shape errors of the two face planes of the window distort the wave front of the transmitted infrared rays and affect the performance of optical devices or measurement devices incorporating such windows.

Additionally, measurement of the surface characteristics of both faces of planar opaque specimens such as disc platters and semiconductor wafers is often desirable when flatness, parallelism, etc are critical.

On the other hand, the surface shape of a transparent plane window (i.e. one which is able to transmit visible light) can be conveniently measured by using an optical interferometer employing a visible wavelength laser. In this case, the wavefront representing relative surface characteristics of the plane window as well as the surface shape of each plane face can be measured and then, the influences of the plane window on the performance of the optical device can be grasped precisely.

However, in the case of the infrared window or a metal window through which visible light can not be transmitted as well as other opaque planar objects such as disc platters and semiconductor wafers, the surface characteristics must be measured using another method instead of the conventional one employing the visible laser optical interferometer.

FIG. 1 is a diagram showing a conventional optical interferometer surface measurement apparatus.

As shown therein, the conventional optical interferometer apparatus for measuring the surface characteristics of a specimen such as an infrared window, a metal window, etc., includes a light source 1 generating a light beam of a predetermined wavelength; an optical device 2 changing the light beam generated from the light source I into a collimated light beam 5; a beam splitter (semi-reflective mirror) 3 splitting the light beam 5 into two beams, a reference light beam 5a and a test light beam 5b which respectively irradiate a specimen 4 of which the surface characteristics are to be measured; and a reference mirror 6, whereby, the reflected reference light beam 5a′ reflected from the reference mirror 6 and the beam splitter 3 interferes with the reflected test light beam 5b′ reflected from-the surface of the specimen 4 and transmitted back through the beam splitter 3; and an imaging device 7 imaging the interference fringe pattern made by interference of the two reflected light beams 5a′, 5b′.

The imaging device 7 includes a semi-reflective mirror (beam splitter) 7a located between the light source 1 and the optical device 2, and a camera device 7b.

The conventional surface measurement apparatus having the above-described structure measures the surface characteristics of the specimen 4 by an interferometric technique. However, from this only one of the surfaces of the specimen 4 can be measured, and therefore, overall analysis of the wavefront transmitted by both surfaces of the specimen 4 cannot be accomplished simultaneously and the optical performance of the window cannot be measured precisely.

If an interferometer using an infrared laser, which penetrates, through the infrared window is used, the above problems can be solved. This is the same as using the visible laser interferometer for measuring the transparent window. However, in the case of the infrared laser interferometer, the light is invisible, and therefore, optical alignment of the measuring system is difficult and a different laser should be used according to the infrared media, which have respective transparent bands of wavelength.

### SUMMARY OF THE INVENTION

Therefore, an object of this present invention is to provide a surface comparison apparatus which is able to measure the parallelism and relative surface shape of both planar faces of a thin plate specimen simultaneously.

To achieve the above object of the present invention, as embodied and broadly described herein, there is provided a surface comparison apparatus comprising: a light source for generating light having a predetermined wavelength; an optical device for changing, the light generated from the light source into a collimated light beam; a beam splitter for splitting the collimated light beam into two light beams, a first test light beam and a second test light beam; a plurality of mirrors for directing the first test light beam and the second test light beam to irradiate the respective surfaces of a specimen and for directing first and second reflected light beams from the specimen back to the beam splitter and optical device to form an interference fringe pattern; and a display device for displaying the interference fringe pattern made by interference of the two reflected light beams.

Also, there is provided a surface comparison method comprising: a step of irradiating parallel collimated light beams onto both surfaces of a specimen after dividing it into two paths; a step of causing the reflected light beams reflected from the both surfaces of the specimen to interfere with each other; and a step of measuring surface shape characteristics of the surfaces relative to the each other.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic diagram showing an optical interferometric conventional surface measurement apparatus;

FIG. 2 is a schematic diagram showing an optical interferometric surface comparison apparatus according to the present invention;

FIG. 3 is a schematic diagram showing a case that a pentagonal prism is used in the optical interferometric surface comparison apparatus according to the present invention;,

FIG. 4 is a schematic diagram showing a case that the paths of parallel collimated light beams form a triangle shape in the optical interferometric surface comparison apparatus according to the present invention;

FIG. 5 is a diagram showing an interference pattern when the optical interferometric surface comparison apparatus according to the present invention is aligned in a state that there is no specimen;

FIG. 6A is a diagram showing an interference pattern for one surface of a specimen measured by the conventional optical interferometric surface measurement apparatus, and FIG. 6B is a diagram showing a surface profile of the one surface of the specimen obtained from the interference pattern in FIG. 6A;

FIG. 7A is a diagram showing, an interference pattern for another surface of the specimen measured by the conventional optical interferometric surface measurement apparatus; and FIG. 7B is a view showing a surface profile of the other surface of the specimen obtained from the interference pattern in FIG. 7A; and

FIG. 8A is a view showing an interference pattern of the light beams 15a′ and 15b′ reflected from both surfaces of a specimen measured by the optical interferometric surface comparison apparatus according to the present invention, and FIG. 8B is a view showing a surface profile of the specimen obtained from the interference pattern in FIG. 8A.

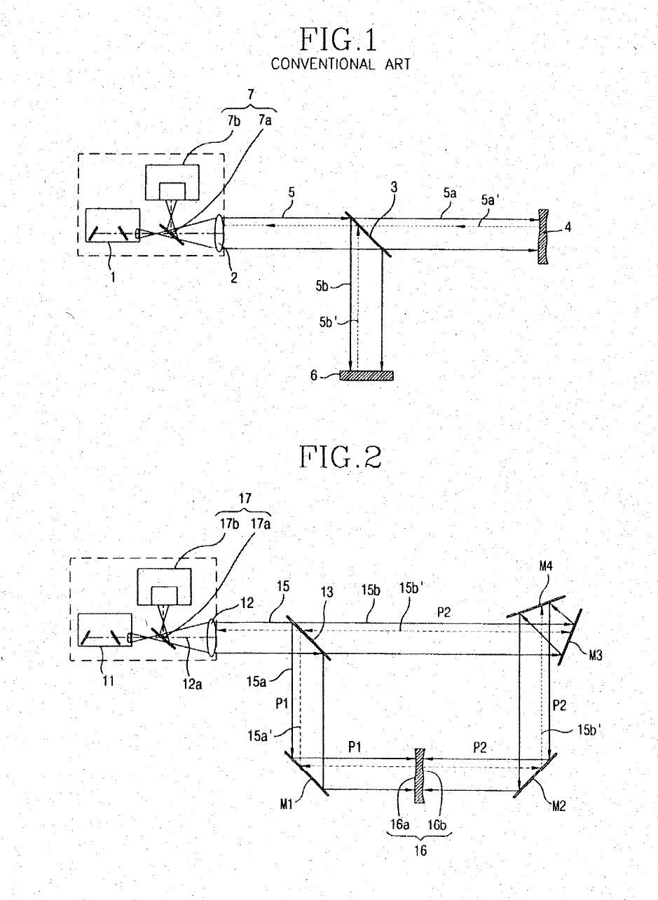

### DETAILED DESCRIPTION OF THE PREFERRED EMBODIMENTS

Reference will now be made in detail to the preferred embodiments of the present invention, examples of which are illustrated in the accompanying drawings.

FIG. 2 is a diagram showing an optical interferometric surface comparison apparatus according to the present invention.

As shown therein, the optical interferometric surface comparison apparatus according to the first embodiment of the present invention includes: a light source 11 generating light having a predetermined wavelength; an optical device 12 changing the light into a collimated light beam 15; an irradiating system dividing the collimated light beam 15 into two light beams 15a, 15b and conducting the respective beams along respective separate paths (P1 and P2) to be made incident normally upon both respective surfaces 16a and 16b of a specimen 16 to be examined, and for conducting the reflected light beams 15a′, 15b′, which are respectively reflected off the surfaces 16a, 16b, in respectively opposite directions to the incident light beams 15a, 15b and combining the reflected beams 15a′, 15b′; and an imaging device 17 imaging and displaying the interference pattern to be observed.

The present invention adopts a visible laser source and optical path of a Twyman-Green interferometer. Herein, the Twyman-Green interferometer (referring to http://cord.org/cm/leot/course10_Mod06/Module10-6.htm) is known as useful for measuring defects of the components of an optical device such as a lens, prism, and plane window. The irradiating system includes a beam splitter 13 such as a semireflective mirror which is capable of dividing the collimated light beam 15 into two beams, 15a and 15b which propagate along the separate respective paths (P1 and P2), and reflectors arranged on the respective paths (P1 and P2) to change i.e., bend the propagating direction of the light beams 15a and 15b.

As shown in FIG. 2, the paths (P1 and P2) construct a quadrangle such as a rectangle (in an exemplary embodiment) or parallelogram. The beam splitter 13 is located at a first apex of the quadrangle formed by the paths P1 and P2 as a dividing portion in which the beam splitter 13 divides the collimated light beam 15 into the two light beams 15a and 15b and the quadrangle has first, second, third, and fourth sides, and second, third, and fourth apexes in a counter-clockwise direction from the first apex, referring to FIG. 2.

The first path P1 is bent at the first apex and the second apex, and reaches one surface 16a of the specimen 16 located along the second side of the rectangle so at to be normally incident thereon. In addition, the second path P2 passes through the first apex, is bent at the fourth and third apexes, and reaches the other surface 16b of the specimen 16 so at to be normally incident thereon. The specimen 16 may be located along any of the first, third, or fourth sides of the rectangle according to circumstances.

The first path P1 is formed by the beam splitter 13 located on the first apex and the reflector M1 located on the second apex, and the second path P2 is formed by the beam splitter 13 located on the first apex, by a pair of reflectors M3 and M4 arranged as an erecting corner reflector and located on the fourth apex and by a reflector M2 located on the third apex.

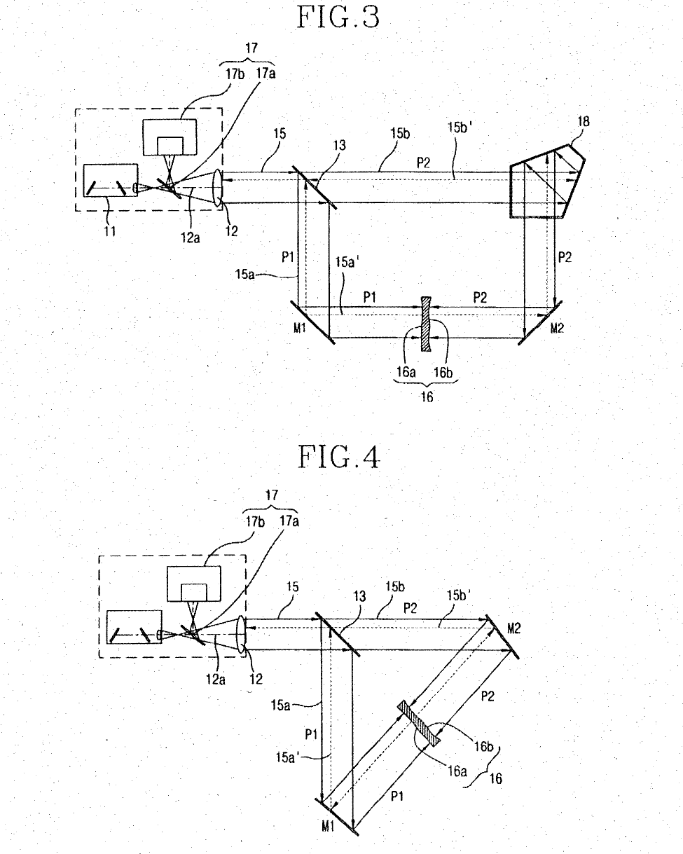

FIG. 3 is a schematic diagram showing another embodiment of the optical interferometric surface comparison apparatus according to the present invention wherein a pentagonal prism 18 serving as an erecting reflector is used in instead of the pair of mirrors M3, M4, in the embodiment shown in FIG. 2, and FIG. 4 is a schematic diagram showing yet another embodiment of the optical interferometric surface comparison apparatus according to the present invention wherein the paths P1, P2 of the parallel light beams 15a, 15b form a triangle.

In addition, in case of the surface comparison apparatus shown in FIG. 2, the paths P1, P2 of the collimated light beams 1 5a, 1 5b form a square. However, as shown in FIG. 4, the paths (P1 and P2) of the light beams 15a, 15b in the surface comparison apparatus according to the present invention may form a triangle. In this case, the beam splitter 13 is located in a first apex of the triangle formed by the paths P1 and P2, as a dividing portion in which the beam splitter 13 divides the light beam generated by the light source 11 the into the two light beams 15a and 15b and the quadrangle have first, second, and third sides and second, and third apexes in counterclockwise direction from the first apex referring to FIG. 3.

The incident light beam 15a propagated along the first path P1 is bent at the first apex, bent again at the reflector M1 located on the second apex, and reaches and is normally incident upon one surface 16a of the specimen located along the second side. In addition, the second incident light beam 15b propagated along the path P2 passes through the first apex, is bent at the reflector M2 located on the third apex, and reaches and is normally incident upon the other surface 16b of the specimen 16.

Also, the first and second paths (P1 and P2) are formed to be precisely aligned normally on a point where the specimen is located after the parallel light beams 15a, 15b have passed along the respective paths (P1 and P2).

The incident light beams 15a, 15b are reflected from the respect surfaces of the specimen, and the reflected light beams 15a′, 15b′ passes along the respective paths P1, P2 and are combined at the beam splitter 13. The combined light beam 15′ progresses toward the optical device 12, and incident on a semi-reflective mirror 17a of the imaging device 17 described hereafter.

The imaging device 17 is located between the light source 11 and the optical device 12, and includes a semi-reflective mirror 17a for reflecting i.e. bending the interfered parallel light beams 15a′, 15b′ induced through the optical device 12, and a camera device 17b for photographing the interference fringe pattern produced by the interfered light beams 15, 15′ reflected by the semi-reflective mirror 17a.

The surface comparison apparatus according to the present invention having the above construction, is able to measure the relative parallelism of the two surfaces of a specimen by comparing the wavefronts of visible rays as if they were transmitted through a nontransparent window. That is, if it is assumed that an index of refraction of the infrared window medium is n(λ′) and the index of refraction is distributed evenly, and if the measured relative shape error is W(r,ψ) for a window aperture, the wavefront function of light W′ after the light is transmitted through the window can be represented by the following equation 1.

W′(r,ψ)=n(λ′)W(r,ψ)/λ′ (1)

Herein, λ represents the wavelength of the infrared rays.

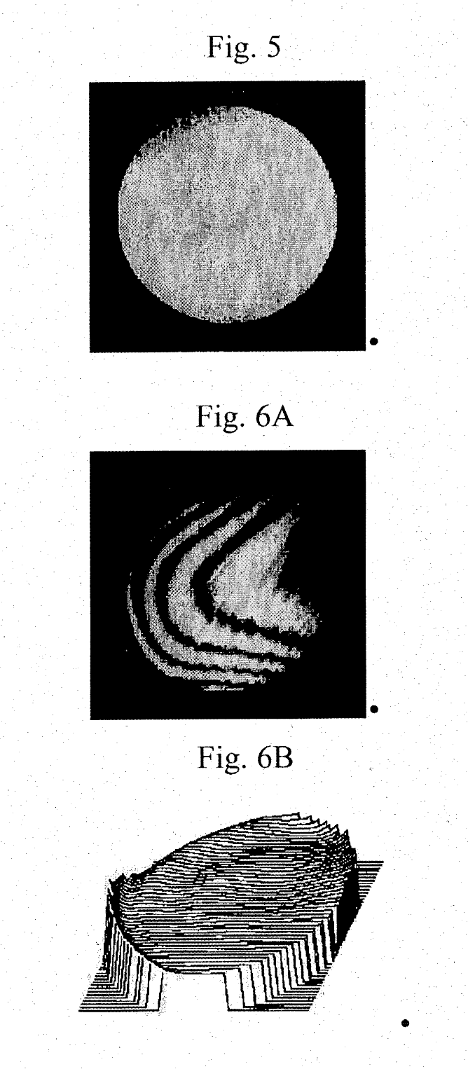

FIG. 5 is a diagram showing an interference pattern when the surface comparison apparatus according to the present invention is aligned.

As shown in FIG. 2, the surface comparison apparatus is aligned such that the parallel light beam 15 of the interferometer is divided at the beam splitter 13, and the reflected light beam 15a′ proceeding in the clockwise direction and the reflected light beam 15b′ proceeding in the counter clockwise direction meet at the beam splitter 13, and are converged by the optical device 12, and bent at the semi-reflective mirror 17a.

In addition, circular images of the light beams may not be agree with each other due to the structure of the optical system. Therefore, in optical axis alignment of the optical system, the reflectors are adjusted so that the circular images are coincided on a screen placed in the position of the specimen, a pin hole is put on the position of the screen, and fine controlling of the optical axis alignment is performed while viewing the image received by the camera on a monitor so that the two images of the pin hole formed by the light beams proceeding in the two directions are coincided. The alignment is identified while moving the position of the pin hole, and after that, when the alignment is completed, the pin hole is removed and the interference pattern is identified.

The optical alignment is adjusted so that the number of the interference pattern fringes is less than 1 throughout the entire screen, and the interference pattern obtained after the optical alignment is shown in FIG. 5. After that, the specimen 16 to be measured is put in the screen position of the surface comparison apparatus, and the paths of the light beams 15a, 15b are controlled so that the beams irradiated onto the surfaces 16a, 16b of the specimen 16 can be incident normally onto the respective surfaces 16a, 16b of the specimen 16a, 16b, i.e. perpendicularly.

FIG. 6A shows an interference pattern for one surface of the specimen measured by the conventional surface measurement apparatus, and FIG. 6B shows the surface profile of the one surface of the specimen obtained from the interference pattern shown in FIG. 6A.

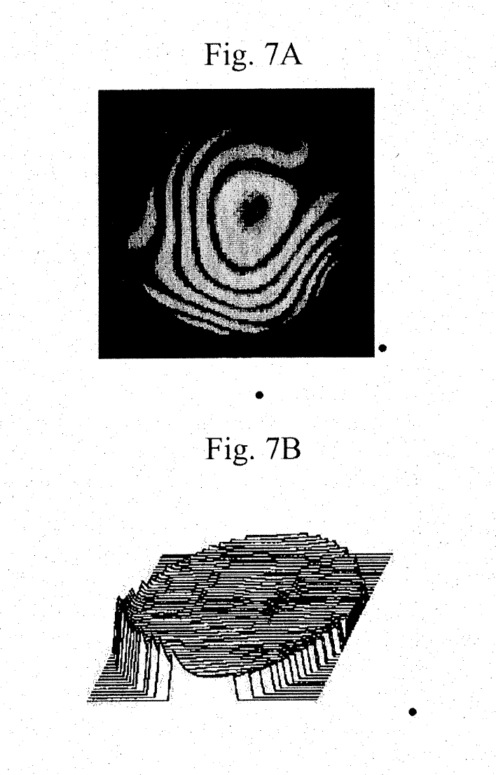

FIG. 7A shows an interference pattern for the other surface of the specimen measured by the conventional optical interferometric surface measurement apparatus, and FIG. 7B shows the surface profile of the other surface of the specimen obtained from the interference pattern shown in FIG. 7A.

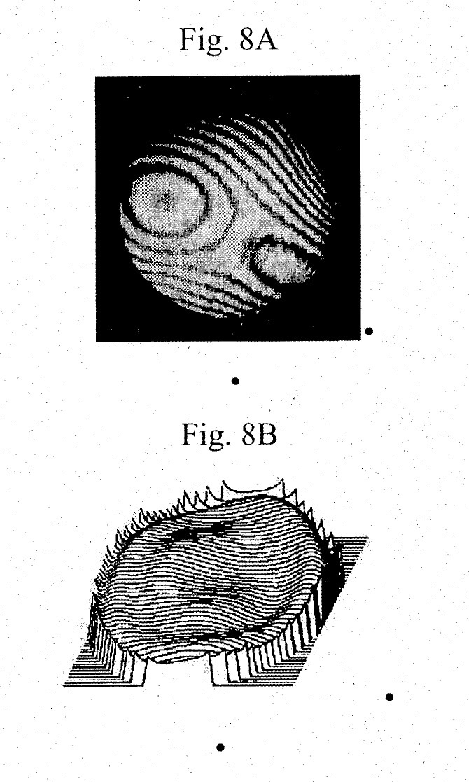

FIG. 8A shows an interference pattern of the light beams 15a′, 15b′ respectively reflected from the both surfaces 16a, 16b of the specimen measured by the optical interferometric surface comparison apparatus according to the present invention, and FIG. 8B shows the surface profile of the specimen 16 obtained from the interference pattern shown in FIG. 8A.

On the other hand, the result of measuring the surfaces of a specimen using the conventional surface measurement apparatus and the result of measuring the surfaces of a specimen using the surface comparison apparatus according to the present invention will be compared as follows.

The object the relative surface shape of which is to be measured is an infrared filter used in equipment for measuring the modulation transfer function (MTF) of an infrared optical system. The interference pattern of one surface of the specimen measured by the conventional surface measurement apparatus or method is shown in FIG. 6A, and the surface profile of the one surface obtained from the interference pattern by using an interference pattern analyzing program is shown in FIG. 6B.

The surface shape error is the result of dividing the wavefront error by 2. In Zernike coefficients of the measured wavefront error, the defocus is 0.83λ, the astigmatism is 5.43λ, the coma is 4.01λ, and the spherical aberration is 1.98λ. Herein, λ is the wavelength of the He—Ne laser, which is the light source, used in the surface comparison apparatus, and the wavelength is 0.631μm.

The interference pattern of the other surface of the specimen measured by the conventional surface measurement apparatus or method, and the surface profile of the other surface obtained by using the interference pattern analyzing program are shown in FIG. 7A and FIG. 7B, respectively. The surface shape error is the result of dividing the wavefront error by 2 the same as above. In Zernike coefficients of the measured light wave surface, the defocus is 3.13λ, the astigmatism is 3.7λ, the coma is 9.27λ, and the spherical aberration is 13.13λ.

On the other hand, the interference pattern measured by the surface comparison apparatus and method according to the present invention, and the wavefront error of the window obtained on the basis of the interference pattern are shown in FIG. 8A and FIG. 8B, respectively.

As a result of analyzing the interference pattern, in Zernike coefficients of the measured wavefront error, the tilt is 1.98λ, the defocus is −0.68λ, the astigmatism is 0.69λ, the coma is 1.83λ, and the spherical aberration is −1.68λ.

Herein, the tilt indicates the parallelism between both surfaces, and the other coefficients indicate relative shape errors between the respective surfaces of the specimen.

As described above, in the case of the conventional surface measurement apparatus and method, if the surfaces of the specimen are measured alternately, the parallelism between the two surfaces cannot be measured and it is difficult to coincide the positions, which are to be measured, and thereby many errors are liable to be generated in the measuring process.

However, according to the surface comparison apparatus and method of the present invention, the interference pattern obtained and the shape of the light wave front obtained from the interference pattern have relative values for the both surfaces, and therefore, the parallelism of the both surfaces of the specimen and the surface characteristics can be measured in a simple way.

In the surface comparison apparatus and method according to the present invention, the collimated light beam is split into two beams, and the light beams are irradiated onto and reflected from the both respective surfaces of the specimen, and interfered with each other to obtain the interference pattern. And the parallelism and the relative surface characteristics for the both surfaces of the specimen can be measured simply from the interference pattern, and the interferometer can be constructed and aligned in a simple way.

In particular, the optical interferometric surface comparison apparatus in accordance with the present invention compares one surface of a specimen referring to the other surface without using another reference surface, and easily measures relative surface profile errors between both surfaces which would distort the wavefront of the transmitted infrared rays and affect the performance of optical devices or measurement devices incorporating infrared windows.

Meanwhile, the optical interferometric surface comparison apparatus in accordance with the present invention, can be easily adapted for comparing the surfaces of non-planar specimens such as lenses, etc.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A surface comparison apparatus comprising:
a light source generating light having a predetermined wavelength;
an optical device changing the light into collimated light;
an irradiating means for irradiating the parallel ray on both surfaces of a specimen which needs to be measured after dividing the parallel light into two paths and making the lights, which are reflected on both surfaces, be focused on opposite direction of the parallel light after passing through the paths and be interfered with each other; and
an imaging means for imaging interference pattern made by interfering the reflected lights.

2. The apparatus of claim 1, wherein the paths comprise a first and a second paths forming a rectangle having a dividing portion divided perpendicularly with an optical axis of the optical device as a first apex, and having, second, third, and fourth sides, and second, third, and fourth apexes toward a direction from the first apex, and
the first path passes the first apex and the second apex, and reaches one surface of the specimen located on the second side, and the second path passes the first apex, fourth and third apexes, and reaches the other surface of the specimen.

3. The apparatus of claim 2, wherein a beam splitter is located on the first apex to divide the path of the parallel light into the first and second paths.

4. The apparatus of claim 3, wherein a reflector is installed on the second apex, a pair of reflectors are installed on the fourth apex, and a reflector is installed on the third apex.

5. The apparatus of claim 3, wherein a reflector is installed on the second apex, a pentagonal prism is installed on the fourth apex, and a reflector is installed on the third apex.

6. The apparatus of claim 1, wherein the paths comprises a first and a second paths constructing a triangle making a dividing portion which is divided perpendicularly with the optical axis of the optical device as a first apex, and having first, second, and third sides and second, third apexes toward a direction from the first apex, and
the first path passes the first apex, the second apex, and reaches one surface of the specimen located on the second side, and the second path passes the first apex, the third apex, and reaches the other surface of the specimen.

7. The apparatus of claim 6, wherein a beam splitter is installed on the first apex, and reflectors are installed on the second and third apexes.

8. The apparatus of claim 1, wherein the display means comprises:
a beam splitter located between the light source and the optical device for reflecting the interfered parallel lights induced through the optical device; and
a camera device for photographing the parallel lights reflected by the semi-reflective mirror.

9. The apparatus of claim 1, wherein the parallel light is divided into two paths by the beam splitter located on an optical axis of the optical device.

10. The apparatus of claim 1, wherein the light is visible ray.

11. The apparatus of claim 1, wherein the specimen is reflective through which the visible ray cannot be transmitted.

12. A surface comparison method comprising:
a step of dividing parallel light into two paths, irradiating the light on both surfaces of a specimen to be reflected thereon;
a step of interfering the lights reflected by the both surfaces of the specimen with each other; and
a step of measuring a surface shape of another surface based on a surface shape of one surface according to characteristics of the interfered reflected lights.

13. The method of claim 12, wherein the parallel lights of respective paths are reflected odd or even number of times until the parallel light is divided, irradiated on both surfaces of the specimen, and reflected to be interfered.
